(19) United States
(12) Patent Application Publication
(10) Pub. No.: US 2017/0180190 A1
(43) Pub. Date: Jun. 22, 2017

(54) MANAGEMENT SYSTEM AND NETWORK ELEMENT FOR HANDLING PERFORMANCE MONITORING IN A WIRELESS COMMUNICATIONS SYSTEM

(71) Applicant: Telefonaktiebolaget LM Ericsson (publ), Stockholm (SE)

(72) Inventors: Ferenc KUBINSZKY, LINKÖPING (SE); Hans IHLSTRÖM, LINKÖPING (SE); Àkos KOVÁCS, Stockholm (SE)

(21) Appl. No.: 15/117,043

(22) PCT Filed: Feb. 10, 2014
(86) PCT No.: PCT/SE2014/050158

§ 371 Date: Aug. 5, 2016

(51) Int. Cl. H04L 12/24; G06F 11/34; H04L 12/18; H04L 12/26

(52) U.S. Cl. CPC H04L 41/0659; H04L 41/5009; H04L 41/0686; H04L 41/0645; H04L 41/0677; H04L 43/08; G06F 11/3466; H04L 12/1863

(57) ABSTRACT

Handling of performance monitoring in a wireless communications system (100) comprising a transport network (150) relating to infrastructure for data transport in the wireless communications system (100). A management system (160) monitors (302, 401) one or more KPIs and detects (308, 402) that the monitored KPIs indicate a key performance degradation. Network elements (151-156) associated with the transport network (150), and those at least potentially are involved in causing the key performance degradation, are identified. The management system (160) sends one or more requests to the identified network elements (151-156). The one or more requests request the identified network elements (151-156) to perform performance measurements and report results thereof to the management system (160). The performance measurements comprise measurements regarding the transport network (150).

### TECHNICAL FIELD

Embodiments herein relate to a method performed by a management system of a wireless communications system, such as telecommunications system, a management system, a method performed by a network element of the wireless communications system and a network element. In particular embodiments herein relate to handling performance monitoring in the wireless communications system.

### BACKGROUND

Communication devices such as wireless devices may be also known as e.g. user equipments (UEs), mobile terminals, wireless terminals and/or mobile stations. A wireless device is enabled to communicate wirelessly in a cellular communications network, wireless communications system, or radio communications system, sometimes also referred to as a cellular radio system, cellular network, cellular communications system or simply cellular system. A typical example of such system or network, depending on terminology used, is a telecommunications system for mobile communications. The communication may be performed e.g. between two wireless devices, between a wireless device and a regular telephone and/or between a wireless device and a server via a Radio Access Network (RAN) and possibly one or more core networks, comprised within the wireless communications system. The wireless device may further be referred to as a mobile telephone, cellular telephone, laptop, Personal Digital Assistant (PDA), tablet computer, just to mention some further examples. The wireless device may be, for example, portable, pocket-storable, hand-held, computer-comprised, or vehicle-mounted mobile device, enabled to communicate voice and/or data, via the RAN, with another entity, such as another wireless device or a server.

The cellular communications network covers a geographical area which is divided into cell areas, wherein each cell area is served by at least one base station, e.g. a Radio Base Station (RBS), which sometimes may be referred to as e.g. “eNB”, “eNodeB”, “NodeB”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided according to a Radio Access Technology (RAT) and at a carrier frequency by the base station at a base station site. The base station may support one or several communication technologies, such as RATs. Cells may overlap so that several cells cover the same geographical area. A base station serves a cell by providing radio coverage such that one or more wireless devices or terminals located in the geographical area where the radio coverage is provided may be served by the base station. One base station may serve one or several cells. When one base station serves several cells, these may be served according to the same or different RATs, and/or may be served at same or different carrier frequencies. The base stations communicate over the air interface operating on radio frequencies with one or more wireless devices within range of the base stations.

In some RANs, several base stations may be connected, e.g. by landlines or microwave, to a radio network controller, e.g. a Radio Network Controller (RNC) in Universal Mobile Telecommunications System (UMTS), and/or to each other. The radio network controller, also sometimes termed a Base Station Controller (BSC) e.g. in GSM, may supervise and coordinate various activities of the plural base stations connected thereto. GSM is an abbreviation for Global System for Mobile Communications (originally: Groupe Spécial Mobile). In 3rd Generation Partnership Project (3GPP) Long Term Evolution (LTE), base stations, which may be referred to as eNodeBs or eNBs, may be directly connected to other base stations and may be directly connected to one or more core networks.

Wireless communication systems following Universal Mobile Telecommunications Systems (UMTS) technology, were developed as part of Third Generation (3G) Radio Systems, and is maintained by the Third Generation Partnership Project (3GPP). UMTS is a third generation mobile communication system, which evolved from the GSM, and is intended to provide improved mobile communication services based on Wideband Code Division Multiple Access (WCDMA) access technology. UMTS Terrestrial Radio Access Network (UTRAN) is essentially a radio access network using wideband code division multiple access for wireless devices. High Speed Packet Access (HSPA) is an amalgamation of two mobile telephony protocols, High Speed Downlink Packet Access (HSDPA) and High Speed Uplink Packet Access (HSUPA), defined by 3GPP, that extends and improves the performance of existing 3rd generation mobile telecommunication networks utilizing the WCDMA. Moreover, the 3GPP has undertaken to evolve further the UTRAN and GSM based radio access network technologies, for example into evolved UTRAN (E-UTRAN) used in LTE.

The expression downlink (DL) is used for the transmission path from the RAN, typically from a base station thereof, to the wireless device. The expression uplink (UL) is used for the transmission path in the opposite direction i.e. from the wireless device to the RAN, typically to a base station thereof.

Each wireless communications system comprises underlying infrastructure responsible for transportation of data, i.e. data transport, in the wireless communications network. The infrastructure is typically referred to as a transport network. For example, in case of a wireless communications system comprising a core network and a RAN, the transport network interconnects the core network and the RAN, parts thereof, and may also include parts, e.g. hubs and switches, that may not belong to neither the core network nor the radio access network since these networks are typically defined on a higher, logical level, while the transport network is defined on a lower, more physical level. There are normally physical entities in the infrastructure that are not defined, and/or are not relevant to discuss as belonging to either one of the core network or the radio access network, but that are part of the transport network. Transport in the transport network involves use of general protocols for what may be called generic data transport and which are not specific for the RAT(s) employed by the wireless communications system. The generic data transport is typically accomplished by means of general standards and protocols for data transport, such as one or more of the following: Internet Protocol (IP), Ethernet, User Datagram Protocol (UDP), Transmission Control Protocol (TCP), Stream Control Transmission Protocol (SCTP).

In contrast to the transport network, the expression “radio network” may be used to refer to higher level data communication and elements defined on said logical, higher level, such as RBS, BSC, RNC, etc., i.e. (logical) network nodes of the wireless communications system. Communication in the radio network results in data transport in the transport network but typically also involve use of higher level communication protocols that are specific for the RAT(s) employed by the wireless communications system.

It is realized that problems in the transport network, which may be problems specific and/or located only in the transport network, may cause problems also in the radio network, e.g. regarding communication of data between (logical) network nodes of the wireless communications network. That is, may have negative impact on higher level performance in the wireless communications system. For example, the characteristic of a packet based Ethernet/IP based transport network may cause delay, delay variation, packet loss and throughput variations, which may have significant impact on performance in the radio network.

There exist standardized transport performance measurement protocols such as G.8013/Y.1731 (see e.g. version 11/13) “OAM functions and mechanisms for Ethernet based networks” Y.1731, and Request For Comments (RFC) 5357 (see e.g. version October 2008) “Two-Way Active Measurement Protocol (TWAMP)”, just to mention some examples. Y.1731 is a layer-2 (L2) protocol, TWAMP is a layer-3 (L3) protocol, where the layers refer to layers according to the so called Open Systems Interconnection (OSI) model. Both protocols may be used for measuring delay, delay variation, loss etc., but tailored for different network scenarios. There are also a number of ways, e.g. depending on RAT involved, to monitor and measure performance on a higher level in the radio network.

### SUMMARY

In view of the above, an object is to facilitate identification of transport network problems that have impact on higher level performance in a wireless communications system.

According to a first aspect of embodiments herein, the object is achieved by a method, performed by a management node, for handling performance monitoring in a wireless communications system. The wireless communications system comprises a transport network relating to infrastructure for data transport in the wireless communications system. The data transport supports communication between logical network nodes of the wireless communications system. The management node monitors one or more key performance indicators, “KPIs”, of the wireless communications system. The management node detects, based on a management system configuration, that the monitored one or more KPIs indicate a key performance degradation. The management node identifies network elements associated with the transport network, which network elements at least potentially are involved in causing the key performance degradation. The management node sends, to the identified network elements, one or more requests requesting the identified network elements to perform performance measurements and report results thereof to the management system. The performance measurements comprise measurements regarding the transport network.

According to a second aspect of embodiments herein, the object is achieved by a computer program that when executed by a processor causes the management system to perform the method according to the first aspect.

According to a third aspect of embodiments herein, the object is achieved by a computer program product, comprising a computer readable medium and the computer program according to second aspect stored on the computer readable medium.

According to a fourth aspect of embodiments herein, the object is achieved by a method, performed by a network element, for handling performance monitoring in a wireless communications system. The wireless communications system comprises a transport network relating to infrastructure for data transport in the wireless communications system. The data transport supports communication between logical network nodes of the wireless communications system. The network element is associated with the transport network. The network element receives, from a management system, one or more requests requesting performance measurements and report back results thereof to the management system. The performance measurements comprise performance measurements regarding the transport network. The network element performs, according to the received one or more requests, the performance measurements.

According to a fifth aspect of embodiments herein, the object is achieved by a computer program that when executed by a processor causes the network node to perform the method according to the fourth aspect.

According to a sixth aspect of embodiments herein, the object is achieved by a computer program product, comprising a computer readable medium and the computer program according to fifth aspect stored on the computer readable medium.

According to a seventh aspect of embodiments herein, the object is achieved by a management node for handling performance monitoring in a wireless communications system. The wireless communications system comprises a transport network relating to infrastructure for data transport in the wireless communications system. The data transport supports communication between logical network nodes of the wireless communications system. The management node is configured to monitor one or more key performance indicators, “KPIs”, of the wireless communications system. Further, the management node is configured to detect, based on a management system configuration, that the monitored one or more KPIs indicate a key performance degradation. Moreover, the management node is configured to identify network elements associated with the transport network, which network elements at least potentially are involved in causing the key performance degradation. Additionally, the management node is configured to send, to the identified network elements, one or more requests requesting the identified network elements to perform performance measurements and report results thereof to the management system. The performance measurements comprise measurements regarding the transport network.

According to an eight aspect of embodiments herein, the object is achieved by a network element for handling performance monitoring in a wireless communications system. The wireless communications system comprises a transport network relating to infrastructure for data transport in the wireless communications system. The data transport supports communication between logical network nodes of the wireless communications system. The network element is associated with the transport network. The network element is configured to receive, from a management system, one or more requests requesting performance measurements and report back results thereof to the management system. The performance measurements comprise performance measurements regarding the transport network. Moreover, the network element is configured to perform, according to the received one or more requests, the performance measurements.

Embodiments herein enable the management node, e.g. an operations and maintenance (O&M) node, to correlate information comprising information based on reports from the performance measurements regarding the transport network. Thereby a report may be provided, e.g. to an operator of the wireless communications system, which report indicates possible causes, including possible causes relating to the transport network, of the key performance degradation in the one or more KPIs, i.e. degradation regarding high level performance in the wireless communications system. In other words, embodiments herein facilitate identification of transport network problems that have impact on said higher level performance. This may in turn e.g. be utilized by an operator of the wireless communications system to e.g. lowering operation expenditure (Opex) costs.

### BRIEF DESCRIPTION OF THE DRAWINGS

Examples of embodiments herein are described in more detail with reference to the appended schematic drawings.

FIG. 1 is a schematic block diagram depicting an example of a wireless communications system in relation to which embodiments herein are explained.

FIG. 2 is a schematic block diagram showing an example of how different network elements may relate to each other.

FIG. 3 is a combined signaling diagram and flowchart schematically illustrating methods according to embodiments herein.

FIG. 4 is a flow chart illustrating a method, performed by a management system, according to embodiments herein.

FIG. 5 is a schematic block diagram illustrating a management system according to embodiments herein.

FIG. 6 is a flow chart illustrating a method, performed by a network element, according to embodiments herein.

FIG. 7 is a schematic block diagram illustrating a network element according to embodiments herein.

FIG. 8a-c are schematic drawings for illustrating embodiments relating to computer program embodiments regarding the management system and the network element.

### DETAILED DESCRIPTION

Before presenting embodiments herein and as part of the development towards embodiments herein, the situation and problem indicated in the Background will be further discussed.

In existing wireless communications systems, e.g. Wi-Fi networks and cellular networks for telecommunication, there are one or more key performance indicators (KPIs) defined regarding high level performance, i.e. relating to performance in the radio network explained in the Background. Examples of KPIs are “Quality of Service (QoS) negotiation success rate for Packet Switched (PS) traffic”, “Speech Quality Indicator UL” and “Speech Quality Indicator DL”, which will be further exemplified below. In general, by KPI as used herein is referred to an indicator, typically predetermined, which indicator reflects important or even crucial performance regarding one or more services specifically provided by the a wireless communications system for serving wireless devices. That is, as used herein, KPI refers to high level performance. Further, for practical application, the KPIs typically are predetermined and/or defined so they correspond to quantifiable measurements.

The KPIs for a wireless communications system are typically monitored constantly by an operator or operators of the wireless communications system.

KPIs and end user experience are negatively affected by faulty behaviour of an underlying transport network as explained in the Background, causing e.g. transmission errors and transport performance degradation. This effect has become greater with the introduction of packet-based Ethernet/IP transport networks.

For advanced troubleshooting and root cause analysis of KPI degradation, a management system, e.g. an operations and maintenance (O&M) system, should be able to access detailed performance indicators regarding the transport network. Such performance indicators may be generated using information adaptively and automatically generated by the participant nodes or functions when transport is the suspected root cause of radio KPI degradation. To facilitate identification of transport network problems that have impact on higher level performance in the wireless communications system, it would be desirable with a solution that supports correlation between performance in the transport network and performance based on KPIs. Thereby, it would be easier to identify transport network problems that actually influence KPIs and be able to spend effort and focus on solving problems that really matters. Hence, it is e.g. desirable to be able to correlate measurement results and performance indicators associated with the transport network and such associated with KPIs, which would facilitate finding root causes of substantial problems and enable effective intervention from an operator of the wireless communications network.

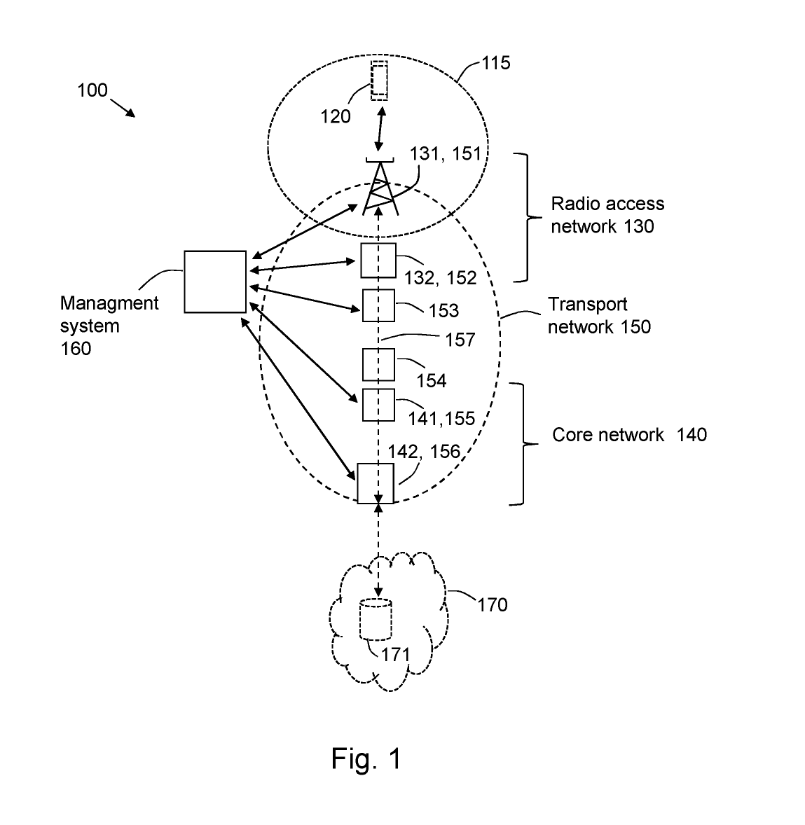

FIG. 1 is a schematic block diagram depicting an example of a wireless communications system 100, in relation to which embodiments herein are explained. The wireless communications system 100 may be of the type discussed above, e.g. based one or more RATs, such as based on GSM, UMTS and/or LTE, and is exemplified as comprising a core network 140 and a RAN 130 interconnected with the core network 140. A base station 131 is shown comprised in the RAN 130, serving a cell 115, and is configured for wireless communication with one or more wireless devices, such as a wireless terminal 120 shown in the figure. The base station 131 is an example of a network node comprised in the wireless communications system 100, or more particularly in the RAN 130. By network node is herein referred to a logical network node in the wireless communications system 100. Another example of a network node in the wireless communications system is a first network node 132 comprised in the RAN 130, as shown in the figure. In case of a GSM based wireless communications system 100, the first network node 132 may correspond to a BSC, and in case of a UMTS based wireless communications system 100, the first network 132 node may correspond to a RNC. In case of a LTE based wireless communications system 100, there may be no first network node 132 in the RAN 130 since the base station 131 in the RAN 130, i.e. an eNB in LTE, may communicate directly with a second network node 142, e.g. a MME or Serving Gateway (SGW), in the core network 140. Further examples of network nodes in the wireless communications system 100 are the second network node 141 and a third network node 142 comprised in the core network 140. In case of a GSM or UMTS based wireless communications system 100, the second network node 141 may correspond to a Serving GPRS Support Node (SGSN) and the third network node 142 may correspond to a Gateway GPRS Support Node (GGSN). In case of a LTE based wireless communications system 100, the second network node 141 may correspond to a Serving Gateway (SGW) and the third network node 142 may correspond to a Packet Data Network (PDN) Gateway.

The third network node 142 may thus function as a gateway node for communication to and/or from an external network 170, e.g. the Internet, which external network may comprise one or many data sources 171 from and/or to which data may be communicated and transported via a data path 157 to and/or from the base station 110 for further communication to and/or from one or more wireless devices, e.g. the wireless device 120.

The wireless communications system 100 also comprises a transport network 150 of such type as described in the Background, i.e. relating to infrastructure suitable for transportation of data, i.e. data transport, in the wireless communications system 100, including e.g. data transport along the data path 157. Examples of such infrastructure include interconnected physical elements that provide a framework enabling communication between logical network nodes of the wireless communications system 100, e.g. between the base station 131, the first network node 132, the second network node 141 and the third network node 142. The data transport supports communication between logical network nodes of the wireless communications system 100. Network elements that will be discussed below are specific examples of the interconnected physical elements that also e.g. include cables for data transport. The data transport in the transport network 150 is typically associated with, e.g. carried out on, lower, or underlying, level(s) compared to one or more levels associated with, e.g. for carrying out, communication between said logical network nodes. The levels may be such defined according to the OSI model.

In the shown example, the transport network 140 interconnects the core network 140, the RAN 130 and parts thereof, and may also include parts, e.g. hubs and switches, that need not belong to neither the core network 140 nor the RAN 130 since these networks are typically defined on a higher, logical, level, while the transport network typically is defined on a lower, underlying level. As already mentioned, data transport in the transport network 150 typically involve use of generic and/or general protocols for data transport and which are not specific for the RAT(s) employed by the wireless communications system 100. Data transport in the transport network 140 is typically accomplished by means of general standards and protocols for data transport, such as one or more of the following: Internet Protocol (IP), Ethernet, User Datagram Protocol (UDP), Transmission Control Protocol (TCP), Stream Control Transmission Protocol (SCTP).

In contrast to the expression “transport network”, the expression “radio network” may be used herein to refer to higher level data communication and elements defined on said logical, higher level, such as the base station 131, the first, second and third network nodes 132, 141-142, respectively, i.e. the previously discussed network nodes of the wireless communications system 100. Communication in the radio network typically involves use of communication protocols that are specific for the RAT(s) employed by the wireless communications system 100. Note that “radio network” as used herein involves the whole wireless communications system 100 and thus may refer to both the RAN 130 and the core network 140 despite that the latter does not contain the word “radio”.

A physical network element relating to the radio network, a so called radio network element (RNE), is a physical network element associated with, or comprised in, a network node of the wireless communications system 100, e.g. the base station 131, the first, second and third network nodes 132, 141-142, but there is not necessarily a 1:1 relationship. For example, a logical network node may involve distributed physical parts where more than one part may correspond to a radio network element.

To accentuate there being a difference, radio network elements associated with the network nodes 131-132, 141-142 shown in FIG. 1 have been numbered separately in FIG. 1. Thus, the exemplifying wireless communications system 100 comprises a first radio network element 151 associated with the base station 131, a second radio network element 152 associated with the first network node 132, a third radio network element 155 associated with the second network node 141 and a fourth radio network element 156 associated with the third network node 142.

Since, in accordance with the above, the radio network may be considered to be built upon, or at least utilizes, the transport network 150, data communication to and/or from each radio network element 151-152, 155-156, e.g. as a result from data communication via the data path 157, involves data transport in the transport network 150. In general, a radio network element such as any one of the radio network elements 151-152, 155-156, provides functionality specific for the radio network, besides transport functionality for the transport network 150, and may e.g. correspond to or be comprised in any one of the following network nodes:

An RBS, that may be a Multi-Standard (MS) RBS, and depending on standard involved and terminology used may be named e.g. BTS, NodeB, eNodeB etc.

A BSC, e.g. when the wireless communications system 100 is based on GSM. The BSC being an example of a radio control and user plane entity.

An RNC, e.g. when the wireless communications system 100 is based on WCDMA. The RNC being an example of a radio control and user plane entity.

A Mobility Management Entity (MME), e.g. when the wireless communications system 100 is based on LTE. The MME being an example of a radio control plane entity.

A gateway (GW), e.g. a session or packet gateway, such as SGW or PDN gateway, e.g. when the wireless communications system 100 is based on LTE. The GW being an example of a radio user plane entity.

On the other hand, a physical network element of the transport network 150, a so called transport network element (TNE), is a network element purely for transport purposes in the transport network 150 and may correspond to e.g. an Ethernet/IP hub, switch, router, firewall etc., just to mention some examples. A first transport network element 153 and a second transport network element 154 are shown as examples in FIG. 1.

Further detailed examples of the radio network elements 151-152, 155-156 and transport network elements 153-153, which may be referred to as network elements 151-156 as common naming to facilitate reading, will follow separately below, e.g. how they may be implemented and relate to each other.

The wireless communications system 100 further comprises a management system 160, e.g. an operation and maintenance (O&M) system. An O&M system is a system that supports operation and maintenance of the wireless communications system 100 and is typically controllable by and provides managing functionality to an operator of the wireless communications system 100. The management system 160 may corresponds to a single entity, i.e. may correspond to a management device, or may correspond to physically separated but interconnected parts. The management system 160 is configured to communicate with the network elements 151-156, as will be described below.

Attention is drawn to that FIG. 1 is only schematic and for exemplifying purpose and that not everything shown in the figure are mandatory for embodiments herein, as will be evident from the below. Also, a wireless communications system that in reality corresponds to the wireless communications system 100 typically comprises several further network nodes, base stations, cells etc., as realized by the skilled person, but which are not shown herein for simplicity.

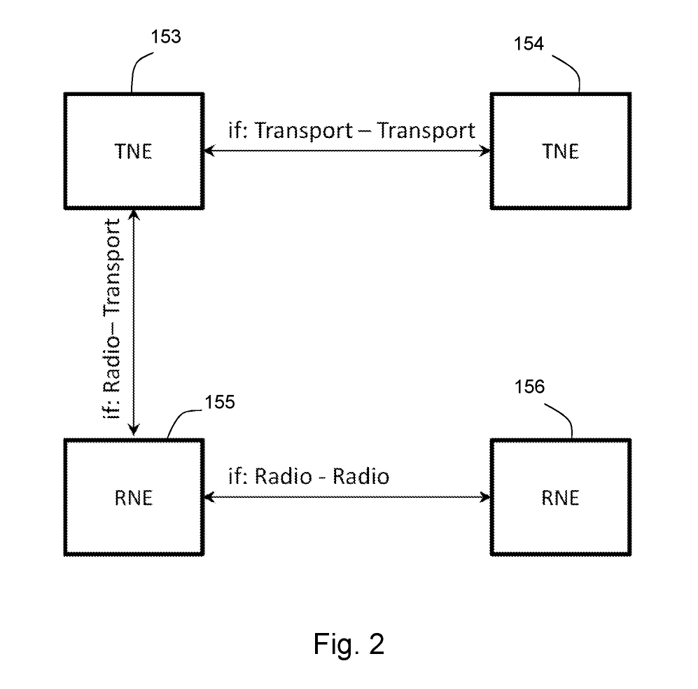

FIG. 2 is a schematic block diagram showing an example of how network elements relevant for embodiments herein may relate to each other. The TNEs 153-154 and the RNEs 155-156 have been selected as examples and correspond to use- and control plane network elements. The following are user- and control plane network interfaces between the network elements shown in FIG. 2:

Interface (if): Transport-Transport

This is an interface between two pure TNEs that typically involves, but not limited to protocols such as Ethernet, IP, IPsec as well as higher level transport and transport-application, e.g. transport performance measurement related protocols.

if: Radio-Transport

This is an interface between an RNE and a THE and may serve as low level transport for radio related functionality. Typical protocols are the same as for the above-mentioned interface Transport-Transport.

if: Radio-Radio

This is an interface between two RNEs and may depend on the type of RNE. For example, the interface may be:

A control and user plane interface between an RBS and an RNC, e.g. Iub, as defined by 3GPP.

A control plane interface between an RBS and a MME, e.g. S1-MME, as defined by 3GPP.

A user plane interface between an RBS and a session or packet GW in LTE systems, e.g. S1-U, as defined by 3GPP.

A control and user plane interface between two RBS' in LTE systems, e.g. X2, as defined by 3GPP.

Each network element shown in FIG. 2 is typically also equipped with an management, or O&M, interface which enables connection to the management system. This interface may be generically described as “if: O&M -*”. Over these interfaces it may be provided configuration, performance and fault management functionality.

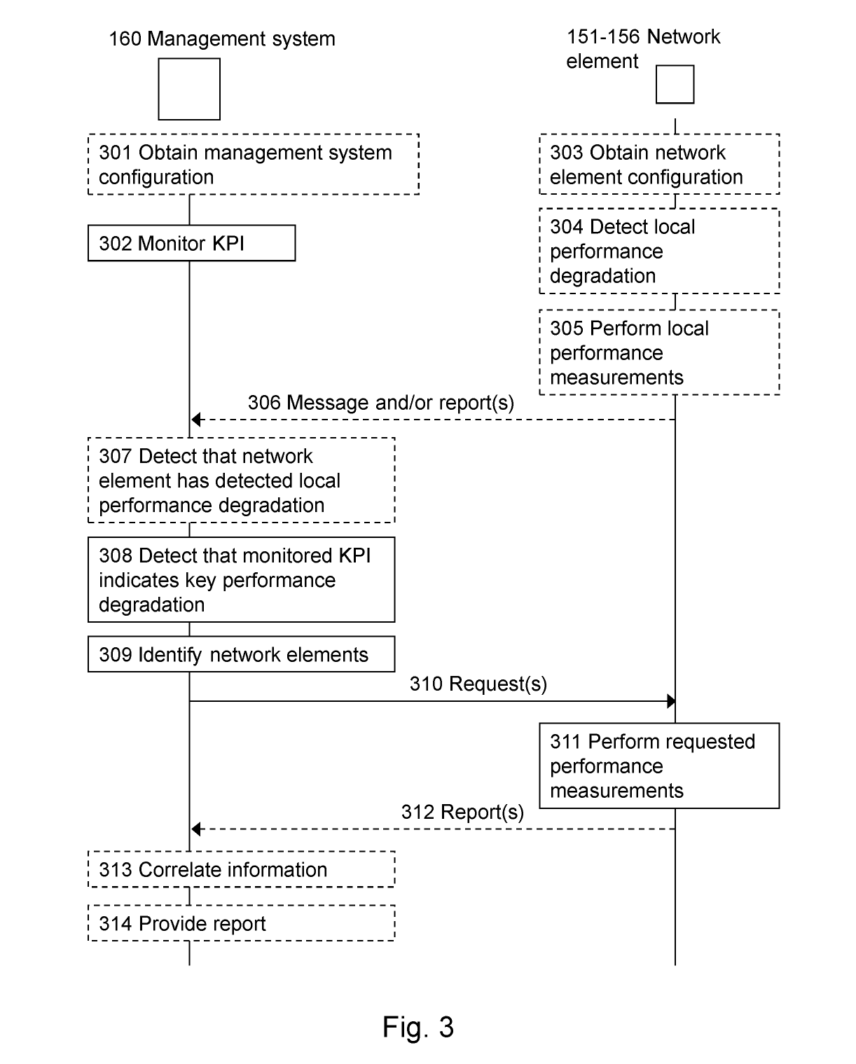

Examples of embodiments herein relating to a method for handling performance monitoring, i.e. monitoring of performance, in the wireless communications system 100, will now be described with reference to the combined signaling diagram and flowchart depicted in FIG. 3. As will be explained, the performance monitoring relates to monitoring of KPIs, i.e. high level performance, in a way that supports finding causes to KPI degradation in an underlying transport network, e.g. the transport network 150. The method will be described with details from two specific examples with different KPIs, namely a Packet Switched (PS) example and a Circuit Switched (CS) example.

In the PS example, a KPI is “Quality of Service (QoS) negotiation success rate for PS traffic”. This KPI indicates the success ratio in percentage when the end use application request for a guaranteed-bandwidth service is granted by a GPRS Support Node (GSN), e.g. GGSN or SGSN. This KPI is highly dependent on the available bandwidth over an end-to-end transmission path between a RBS and GSN, e.g. the base station 131 and the third network node 142.

In the CS example, KPIs are integrity KPIs “Speech Quality Indicator UL” and “Speech Quality Indicator DL”. These relate to monitoring speech quality indicators for both uplink and downlink. Speech quality indicators may correspond to measures of speech quality based on radio quality information. The speech quality may e.g. be determined by monitoring radio conditions for each ongoing call in the RAN 130. The radio conditions may be converted to so called Speech Quality Indexes (SQI) corresponding to speech quality according to “Speech Quality Good (SQI-G)”, “Speech Quality Acceptable (SQI-A)” and “Speech Quality Bad (SQI-B)” for both UL and DL. These indexes show the percentage of good, acceptable and bad speech samples. These KPIs are highly dependent on transport network characteristics such as delay, delay variation and loss between e.g. a RBS and BSC/RNC, e.g. the base station 131 and the first network node 132.

The method comprises the following actions, which actions may be taken in any suitable order. Further, actions may be combined.

Action 301

The management system 160 may obtain a management system configuration, e.g. from or via input by an operator of the wireless communications system 100, which operator may determine the management system configuration. The management system configuration may configure what KPI(s) the management system 160 shall monitor. Moreover, the management system configuration may configure thresholds, alarms etc. to be used by the management system 160 for detecting that at least one of monitored KPI(s) is degraded etc. See actions below for further examples. It is typically advantageous with the management system configuration being at least partly determined by the operator of the wireless communications system 100 since it enables the operator to control and set up performance monitoring to suit its particular needs, requirements etc. and thereby enables a more flexible solution. In some cases the management system 160 may be fully or partly pre-configured with the management system configuration.

In the PS example, the present action may involve that the operator configures a lowest acceptable threshold on said KPI, e.g. that the success rate shall be more than 80%.

In the CS example, the present action may involve that the operator configures lowest acceptable thresholds for said KPIs. For example that the both UL and DL SQI-G shall be greater than 80% and SQI-B shall always be under 5%.

Action 302

The management system 160 monitors one or more KPIs of the wireless communications system 100. As an example, the KPIs relate to performance of the radio network. The monitoring may be based on the management system configuration obtained in Action 301. In the PS and CS examples, the KPI(s) being monitored are as described above for said examples.

Action 303

One or more of the network elements 151-156 may obtain a respective network element configuration, e.g. from or via input by an operator of the wireless communications system 100, which operator may determine the respective network element configuration. The configuration may configure thresholds, alarms, reporting etc. to be applied by said one or more of the network elements 151-156. See actions below for further examples. The respective network element configuration may be received from or via the management system 160. In some cases one or more of the network elements 151-156 may alternatively or additionally be fully or partly pre-configured. It is typically advantageous with at least some network element configurations being at least partly determined by the operator of the since it enables the operator to control and set up performance monitoring to suit their needs, requirements etc. and thereby a more flexible solution is enabled.

In the PS example, the present action may involve that the operator configures the concerned network elements with a sufficient minimal available bandwidth between RBS-BSC/RNC and BSC/RNC-GSN as threshold. For example, that the available bandwidth shall be greater than 30% of total bandwidth over 80% of time. The operator may also start background active measurement sessions between the corresponding nodes so they constantly monitor the threshold, e.g. between the base station 131 and the first network node 132, and between the first network node 141 and the second network node 141 and/or third network node 142. For example sessions based on said TWAMP, e.g. together with RFC 6802 (e.g. version November 2011) “Ericsson Two-Way Active Measurement Protocol (TWAMP) Value-Added Octets”, may be started to continuously monitor, but with low intensity, the available bandwidth without reporting the details to the management system 160.

In the CS example, the present action may involve that the operator configures the concerned network elements, e.g. the first and second radio network elements 151, 152, with thresholds on delay, delay variation and loss. For example, it may be configured that an Abis or Iub delay, delay variation and loss characteristics shall be better that the values specified by one or more applicable standard specifications, e.g. 3GPP standards.

Action 304

At least one of the network elements 151-156 may detect a local performance degradation based on internal performance monitoring. The performance monitoring and/or detection may be based on a respective configuration of the network element(s) involved, e.g. be based on an obtained network element configuration according to Action 303.

In the PS example, the present action may involve that one of the network elements 151-156, e.g. the radio network element 151 comprised in the base station 131, detects local threshold violation, which may be based on a network element configuration with threshold as obtained in Action 303.

In the CS example, the present action may involve that at least one of the first radio network element 151 comprised in the base station 131 and the second radio network element 152 comprised in the first network node 132, detects a local threshold violation, e.g. in said Radio Specific Transport block, which may be based on a network element configuration with threshold as obtained in Action 303.

Action 305

Said at least one of the network elements 151-156 may perform, in response to the detected local performance degradation according to Action 304, local performance measurements. The local performance measurements may be other and/or more detailed and/or more frequent than e.g. measurements underlying what resulted in the detected local performance degradation.

In the PS example, the present action may involve that the involved network element(s), e.g. the first radio network element 151, reconfigures an active measurement session for higher intensity measurements and reporting of the results thereof to the management system 160.

In the CS example, the present action may involve that the involved network element(s), e.g. the first radio network element 151 and the second network element 152, starts one or more active measurement sessions. The active measurement session(s) may be based on TWAMP measurements which measures one-way delay, delay variation and loss for a direction relevant for the detected performance degradation. For example, TWAMP probes may be sent with a proper Differentiated Services Code Point (DSCP) setting and with traffic pattern simulating speech traffic.

Action 306

Said at least one of the network elements 151-156 may send, to the management system 160, a message informing about the detected local performance degradation from Action 304, and/or may send, to the management system 160, one or more reports with results from the local performance measurements performed according to Action 305.

In the PS example, the present action may involve that the concerned network element that detected the local performance degradation, e.g. the first radio network element 151, notifies the management system 160 about the local threshold violation according to Action 304. This may be accomplished explicitly by a message, or implicitly based on the reconfiguration of the active measurement session according to Action 305. Together with the message the involved network element may send detailed measurement reports with results from the local performance measurements performed in Action 305

In the CS example, the present action may involve that the involved network element that detected the local performance degradation, e.g. the first radio network element 151, notifies the management system 160 about the local threshold violation according to Action 304. This may be accomplished explicitly by a message, or implicitly due to the reconfiguration of the active measurement session according to Action 305. Together with the message, the involved network element may send detailed measurement reports with results from the active measurements session(s) measurements performed in Action 305.

Action 307

The management system 160 may detect that said at least one network element of the network elements 151-156 internally has detected the local performance degradation according to Action 304. The detection by the management system 160 may be based on the message and/or reports sent to the management system 160 according to Action 306. Additionally or alternatively, the detection may be based on that the management system 160 identifies that said at least one network element has changed behavior after detection of the local performance degradation, e.g. that it has been reconfigured to, and/or started to, perform the local performance measurements according to Action 305.

In the PS and CS examples, the present action may involve that the management system 160 receives the message according to Action 306 or identifies that a involved network element has been reconfigured as mentioned under Action 305.

Action 308

In this action it is assumed that the management system 160 detects, based on a management system configuration, such as obtained in Action 301, that the monitored one or more KPIs indicate a key performance degradation. The key performance degradation refers to degradation of the monitored one or more KPIs.

The one or more KPIs may be monitored and/or checked regularly, e.g. compared to a threshold or other reference according to the management system configuration, and based on this the management system 160 may determine that it has detected the key performance degradation. In addition and/or alternatively to monitoring and/or checking the one or more KPIs regularly, which may be continuously or at certain intervals, e.g. according to the management system configuration, the one or more KPIs may be monitored and/or checked in response to a trigger. The trigger may e.g. be that the management system detects, according to Action 307 that said at least one network element of the network elements 151-156 internally has detected the local performance degradation. Monitoring and/or checking the one or more KPIs based on such trigger has the advantage that resources for monitoring and/or checking the one or more KPIs may be at least reduced and it also enables a more distributed implementation where processing to a greater extent may take part in the network elements, i.e. be distributed, and higher level processing involving e.g. the management system 160 may be reduced and involve reduced data amounts. This enable a more robust, faster and more efficient implementation.

If the monitored one or more KPIs do not indicate a key performance degradation and the local performance measurements according to Action 305 are being performed, these may be stopped by the management system 160. The local performance degradation and/or the local performance measurements may of course be recorded, and/or reported, but this information may not be necessary to use if there is not also an indication of key performance degradation.

In the PS example, the present action involve that the management system 160 detects that the main KPI shows some degradation based on the threshold according to Action 301. If the management system 160 does not detect that the main KPI shows degradation, the management system 160 may send an instruction to the involved network element(s) to stop the higher intensity measurements according to Action 305 and reporting according to Action 306, if such are ongoing.

In the CS example, the present action involve that the management system 160 detects that the main KPIs show some degradation based on the thresholds according to Action 301. If the management system 160 does not detect that the main KPIs shows degradation, the management system 160 may send an instruction to the involved network element(s) to stop the reporting according to Action 306, if such is ongoing.

Action 309

The management system 160 identifies network elements, e.g. one or more of the network elements 151-156, associated with the transport network 150, which network elements at least potentially are involved in causing the key performance degradation. The identification of the network elements is typically based on network topology information that may have been obtained by the management system 160 e.g. from a data base accessible by the management system 160. The network topology information and/or data base may be available to, and/or maintained by, an operator of the wireless communication system 100. The network topology information may be updated every time there is a relevant change concerning network elements of the wireless communications system 100, e.g. when a network element is removed or added, installed etc. The network topology information comprises information that e.g. identifies network elements of the wireless communications system 100, how they relate, e.g. are connected, to each other, where they are located etc.

The identification in the present action may be based on a management system configuration such as obtained in Action 301. In cases where the management system 160 performs Action 307, the identification of the network elements according to the present action may be at least partly based on the detection of said at least one network element that detected the local performance degradation and/or location of said at least one network element. In other words, identification of the network elements according to the present action may be based on self-identification by at least one of the network elements.

In the PS example, the present action may involve that the management system 160, based on how the main KPI is defined, e.g. knows that the base station 131 and the third network node 142 are involved and thus that e.g. all network elements in-between, i.e. that all network elements 151-156 in the shown example of FIG. 1 are potentially involved.

In the CS example, the present action may involve that the management system 160, based on how the main KPIs are defined, e.g. knows that the base station 131 and the first network node 132 are potentially involved and that there are no other network elements that potentially may be involved.

Action 310

The management system 160 sends, to the identified network elements according to Action 309, e.g. to one or more of the network elements 151-156, one or more requests. The one or more requests are requesting the identified network elements to perform performance measurements and report results thereof to the management system 160. The performance measurements comprise measurements regarding the transport network 150. The performance measurements should be of one or more types that are relevant based on the one or more KPIs. Said sent one or more requests typically request the identified network elements to perform the performance measurements in a synchronized manner, i.e. so they fully or at least partly overlap in time, which is beneficial and often required for correlation of the performance measurements.

The one or more types of performance measurements and/or the one or more requests and/or sending thereof, may be based on a management system configuration, such as obtained in Action 301.

In the PS example, the present action may involve that the management system 160 instructs all at least potentially involved network elements, e.g. network elements 151-156, to start detailed measurements and reporting.

In the CS example, the present action may involve that the management system 160 instructs all involved network elements in the path between base station 131 and the first network node 132, i.e, the first and second radio network elements 151-152, to start detailed measurements and reporting. In case of IP capable network elements a TWAMP measurement session may be used. In case of network elements operating on level 2 (L2), e.g. Ethernet, a Y.1731 based measurement set with proper metrics may be used.

Action 311

Respective network element 151-156 that received the one or more requests according to Action 310 performs, in response to the received one or more requests, the performance measurements.

Action 312

The respective network element 151-156 may send, to the management system 160, which receives, one or more reports with results from the performance measurements performed according to Action 311.

Action 313

The management system 160 may correlate information comprising information from the reports received according to Action 312. Correlation makes it possible to find correlations in different type of performance measurements and/or performance measurements performed by difference network elements. For example may a correlation between the one or more KPIs, when corresponding to the key performance degradation, and performance measurements indicating low bandwidth from a network switch, e.g. corresponding to the transport network element 153, in the transport network 150, indicate that the network switch contributes or even may be a reason for the key performance degradation. The correlation may be based on an analysis between different input parameters corresponding to, or at least based on, results from the performance measurement performed by network elements, and output parameters corresponding to, or at least based on, the KPI(s) indicating key performance degradation, e.g. bad speech quality. The correlation may thus pinpoint input parameters that cause the KPI(s) indicating the key performance degradation, i.e. bad output result. That is, correlation is here used for root cause analysis.

Action 314

The management system 160 provides a report, based on the correlated information, indicating possible causes of the key performance degradation. The provided report may be used by an operator of the wireless communications system 100 and e.g. assist the operator e.g. through operator processes such as network surveillance for pin pointing faults, i.e. trouble shooting.

In the PS and CS examples, the Actions 311-314 may involve that the management system 160 collects results, correlates them and provides a report to the operator with possible root causes of the key performance degradation.

Embodiments herein thus enable the management node 160 to correlate information comprising information based on reports from the performance measurements regarding the transport network 150. Thereby a report may be provided, e.g. to an operator of the wireless communications system 100, which report indicates possible causes, including possible causes relating to the transport network 150, of the key performance degradation in the one or more KPIs, i.e. degradation regarding high level performance in the wireless communications system 100. In other words, embodiments herein facilitate identification of transport network problems that have impact on said higher level performance. This may in turn e.g. be utilized by an operator of the wireless communications system 100 to e.g. lowering operation expenditure (Opex) costs.

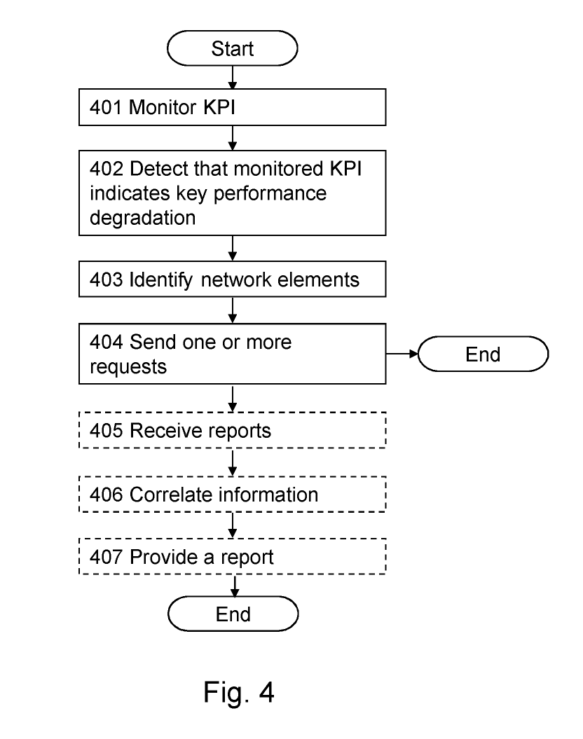

Embodiments herein relating to a method, performed by the management system 160, for handling performance monitoring in the wireless communications system 100, will now be further elaborated and described with reference to the flowchart depicted in FIG. 4. As already mentioned, the wireless communications system 100 comprises the transport network 150 relating to infrastructure for data transport in the wireless communications system 100. The data transport supports communication between logical network nodes, e.g. the base station 131 and the first, second and third network nodes 132, 141-142, respectively, of the wireless communications system 100.

The method comprises the following actions, which actions may be taken in any suitable order. Further, actions may be combined.

Action 401

The management system 160 monitors one or more KPIs of the wireless communications system 100.

This action may fully or partly correspond to action 302 discussed above.

Action 402

The management system 160 detects, based on a management system configuration, that the monitored one or more KPIs indicate a key performance degradation.

The management system configuration may be determined by an operator of the wireless communications system 100.

The detection of the monitored KPI indicating the key performance degradation may be in response to detection by the management system 160 that at least one network element of the network elements 151-156 internally has detected a local performance degradation. The detection of the local performance degradation may be based on a network element configuration configuring said at least one network element. The network element configuration may be determined by an operator of the wireless communications system 100.

This action may fully or partly correspond to action 308 discussed above.

Action 403

The management system 160 identifies network elements, exemplified by the network elements 151-156, associated with the transport network 150, which network elements are at least potentially involved in causing the key performance degradation.

The identification of the network elements may be based on network topology information.

This action may fully or partly correspond to action 309 discussed above.

Action 404

The management system 160 sends, to the identified network elements 151-156, one or more requests requesting the identified network elements 151-156 to perform performance measurements and report results thereof to the management system 160. The performance measurements comprise measurements regarding the transport network 150.

Said one or more requests may further request the identified network elements 151-156 to perform the performance measurements in a synchronized manner.

The performance measurements may be of one or more types that are relevant based on the one or more KPIs.

This action may fully or partly correspond to action 310 discussed above.

Action 405

The management system 160 may receive, from the network elements 151-156 in response to the sent one or more requests, reports with results from the performance measurements.

This action may fully or partly correspond to action 312 discussed above.

Action 406

The management system 160 may correlate information comprising information from the received reports.

This action may fully or partly correspond to action 313 discussed above.

Action 407

The management system 160 may provide a report, based on the correlated information, indicating possible causes of the key performance degradation.

This action may fully or partly correspond to action 314 discussed above.

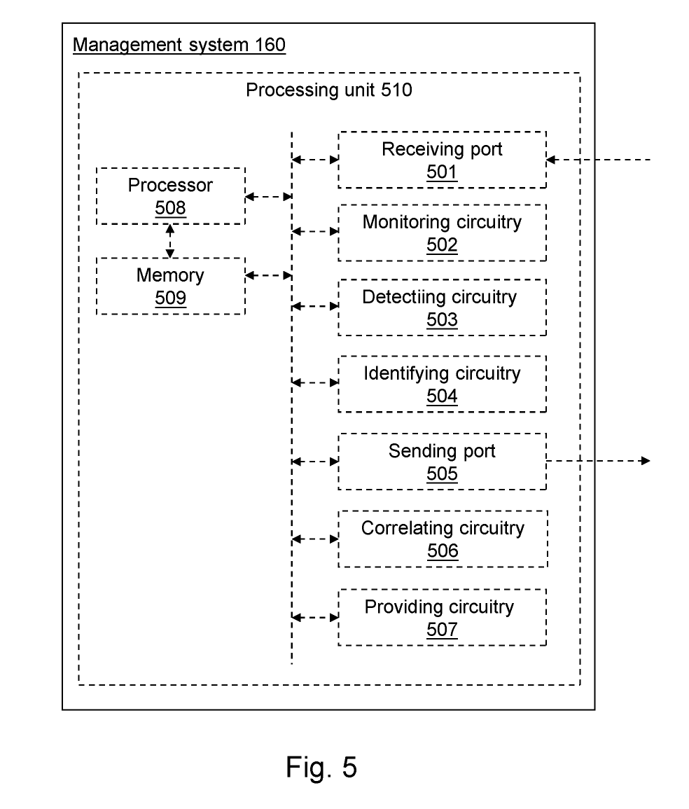

To perform the actions 401-407, for handling performance monitoring in the wireless communications system 100, the management system 160 may comprise an arrangement schematically depicted in FIG. 5.

The management system 160, or a receiving port 501 comprised in the management system 160, may be configured to receive information, e.g. the management system configuration. In some embodiments, the management system 160, or the receiving port 501, is configured to receive, from the network elements 151-156 in response to the sent one or more requests, the reports with results from the performance measurements.

The management system 160, or a monitoring circuitry 502 comprised in the management system 160, is configured to monitor said one or more KPIs of the wireless communications system 100.

The management system 160, or a detecting circuitry 503 comprised in the management system 160, is configured to detect, based on the management system configuration, that the monitored one or more KPIs indicate the key performance degradation.

The management system 160, or an identifying circuitry 504 comprised in the management system 160, is configured to identify the network elements, e.g. the network elements 151-156, associated with the transport network 150, which network elements at least potentially are involved in causing the key performance degradation.

The management system 160, or a sending port 505 comprised in the management system 160, is configured to send, to the identified network elements 151-156, said one or more requests requesting the identified network elements 151-156 to perform the performance measurements and report results thereof to the management system 160. As already mentioned, the performance measurements comprise measurements regarding the transport network 150.

The management system 160, or a correlating circuitry 506 comprised in the management system 160, may be configured to correlate said information comprising the information from the received reports.

The management system 160, or a providing circuitry 506 comprised in the management system 160, may be configured to provide the report, based on the correlated information, indicating possible causes of the key performance degradation.

The embodiments of the management system 160 may be fully or partly implemented through one or more processors, such as a processor 508 depicted in FIG. 5, together with a computer program for performing the functions and actions of embodiments herein relating to the management system 160. In some embodiments the circuitry and ports discussed above may be fully or partially implemented by the processor 508.

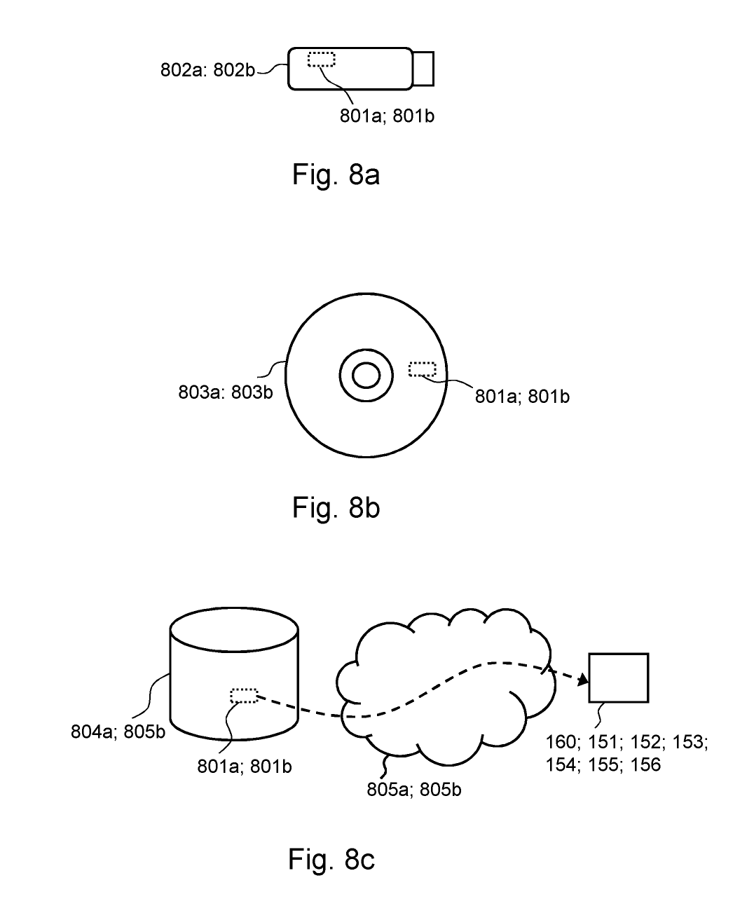

In some embodiments, illustrated with support from the schematic drawings in FIGS. 8a-c, further explained separately below, there is provided a computer program 801a that when executed by a processor, e.g. the processor 508, causes the management system 160 to perform the method according to embodiments herein as described above.

In some embodiments, also illustrated with support from the schematic drawings in FIGS. 8a-c, there is provided a computer program product comprising a computer-readable medium and the computer program 801a stored on the computer-readable medium. By computer readable medium it is excluded a transitory, propagating signal and the computer readable medium may correspondingly be named non-transitory computer readable medium. Non-limiting examples of the computer-readable medium is a memory card or a memory stick 802a as in FIG. 8a, a disc storage medium 803a such as a CD or DVD as in FIG. 8b, a mass storage device 804a as in FIG. 8c. The mass storage device 804a is typically based on hard drive(s) or Solid State Drive(s) (SSD). The mass storage device 804a may be such that is used for storing data accessible over a computer network 805a, e.g. the Internet or a Local Area Network (LAN).

The computer program 801a may furthermore be provided as a pure computer program or comprised in a file or files. The file or files may be stored on the computer-readable memory and e.g. available through download e.g. over the computer network 805a, such as from the mass storage device 804a via a server. The server may e.g. be a web or file transfer protocol (ftp) server. The file or files may e.g. be executable files for direct or indirect download to and execution on the management system 160, e.g. on the processor 508, or may be for intermediate download and compilation involving the same or another processor to make them executable before further download and execution.

The management system 160 may further comprise a memory 509, depicted in FIG. 5, comprising one or more memory units. The memory 509 is arranged to store data, such as configurations and/or applications involved in or for performing the functions and actions of embodiments herein.

Those skilled in the art will also appreciate that the ports and circuitry 501-507 may refer to a combination of analog and digital circuits, and/or one or more processors configured with software and/or firmware (e.g., stored in memory) that, when executed by the one or more processors such as the processor 508, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

As a further example, the management system 160 may comprise a processing unit 510, which may comprise one or more of the circuit(s) and/or port(s) etc mentioned above. As used herein, the term “processing circuit” may relate to a processing unit, a processor, an application specific integrated circuit (ASIC), a field-programmable gate array (FPGA) or the like. As an example, a processor, an ASIC, an FPGA or the like may comprise one or more processor kernels. In some examples, the processing circuit may be embodied by a software and/or hardware module.

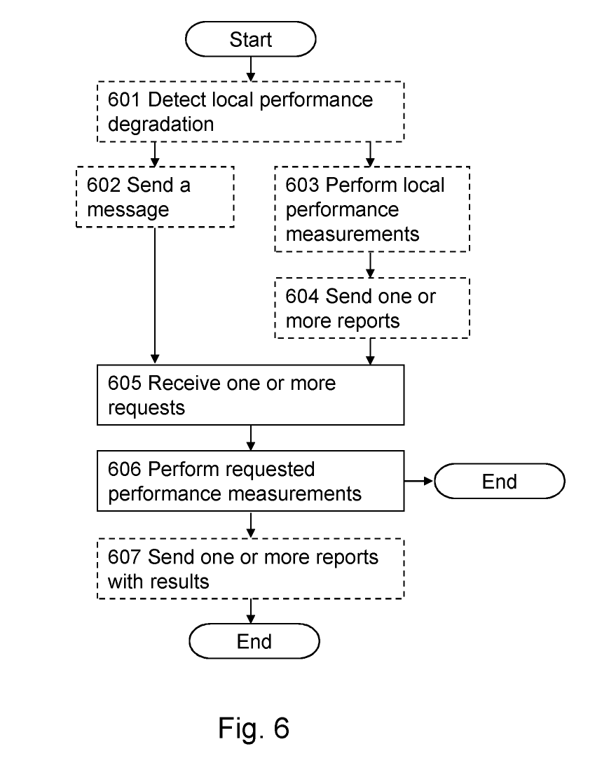

Embodiments herein relating to a method, performed by a network element, e.g. any of the network elements 151-156, denominated network element 151; 152; 153; 154; 155; 156 in the following, for handling performance monitoring in the wireless communications system 100, will now be further elaborated and described with reference to the flowchart depicted in FIG. 6. The network element 151; 152; 153; 154; 155; 156 is, like the network elements 151-156 as mentioned above, associated with the transport network 150, e.g. comprised in the transport network 150. Also as mentioned above, the wireless communications system 100 comprises the transport network 150 relating to infrastructure for data transport in the wireless communications system 100. The data transport supports communication between logical network nodes, e.g. the base station 131 and the first, second and third network nodes 132, 141-142, respectively, of the wireless communications system 100.

The method comprises the following actions, which actions may be taken in any suitable order. Further, actions may be combined.

Action 601

The network element 151; 152; 153; 154; 155; 156 may detect, internally within the network element 151; 152; 153; 154; 155; 156, a local performance degradation based on internal performance monitoring.

The internal detection of the local performance degradation may be based on a configuration of the network element 151; 152; 153; 154; 155; 156, which configuration may be determined by an operator of the wireless communications system 100.

This action may fully or partly correspond to action 304 discussed above.

Action 602

The network element 151; 152; 153; 154; 155; 156 may send, to the management system 160, a message informing about the detected local performance degradation.

This action may fully or partly correspond to action 306 discussed above.

Action 603

The network element 151; 152; 153; 154; 155; 156 may perform, in response to the detected local performance degradation, local performance measurements.

This action may fully or partly correspond to action 305 discussed above.

Action 604

The network element 151; 152; 153; 154; 155; 156 may send, to the management system 160, one or more reports with results from the local performance measurements.

This action may fully or partly correspond to action 306 discussed above.

Action 605

The network element 151; 152; 153; 154; 155; 156 receives, from the management system 160, one or more requests requesting performance measurements and report back results thereof to the management system 160. The performance measurements comprise performance measurements regarding the transport network 150.

Said one or more requests may further request the network element 151; 152; 153; 154; 155; 156 to perform the performance measurements in a synchronized manner in relation to performance measurements performed by other one or more network elements, e.g. one or more of the network elements 151-156 that are not the network element 151; 152; 153; 154; 155; 156 performing the present action.

The performance measurements may be of one or more types that are relevant based on one or more key performance indicators, “KPIs”, of the wireless communications system 100, which KPIs are monitored by the management system 160.

This action may fully or partly correspond to action 310 discussed above.

Action 606

The network element 151; 152; 153; 154; 155; 156 performs, according to the received one or more requests, the performance measurements.

This action may fully or partly correspond to action 311 discussed above.

Action 607

The network element 151; 152; 153; 154; 155; 156 sends, to the management system 160 in response to the received one or more requests, one or more reports with results from the performed performance measurements.

This action may fully or partly correspond to action 312 discussed above.

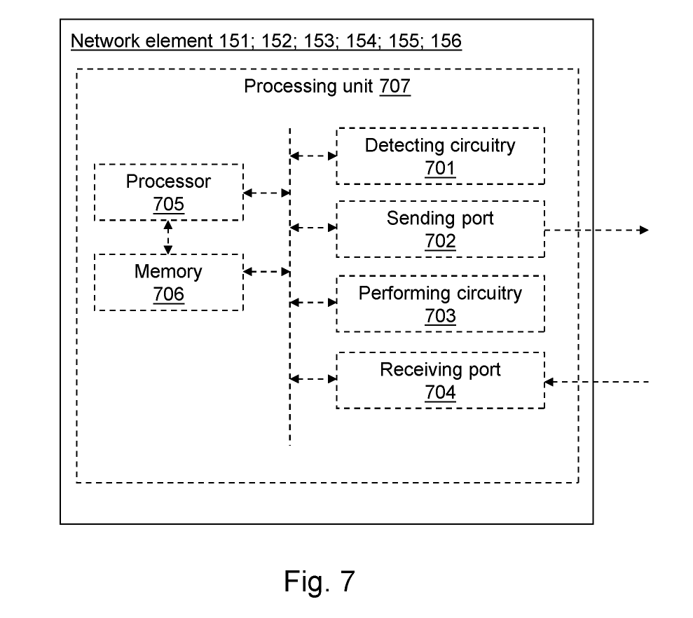

To perform the actions 601-607, for handling performance monitoring in the wireless communications system 100, the network element 151; 152; 153; 154; 155; 156, i.e. any of the network elements 151-156, may comprise an arrangement schematically depicted in FIG. 7.

The network element 151; 152; 153; 154; 155; 156, or a detection circuitry 701 comprised in the network element 151; 152; 153; 154; 155; 156, may be configured to detect, internally within the network element 151; 152; 153; 154; 155; 156, said local performance degradation based on internal performance monitoring.

The network element 151; 152; 153; 154; 155; 156, or a sending port 702 comprised in the network element 151; 152; 153; 154; 155; 156, may be configured to send, to the management system 160, said message informing about the detected local performance degradation.

The network element 151; 152; 153; 154; 155; 156, or a performing circuitry 703 comprised in the network element 151; 152; 153; 154; 155; 156, may be configured to perform, in response to the detected local performance degradation, said local performance measurements. The network element 151; 152; 153; 154; 155; 156, or the sending port 702 comprised in the network element 151; 152; 153; 154; 155; 156, may be further configured to send, to the management system 160, said one or more reports with results from the local performance measurements.

The network element 151; 152; 153; 154; 155; 156, or a receiving port 704 comprised in the network element 151; 152; 153; 154; 155; 156, is configured to receive, from the management system 160, said one or more requests requesting said performance measurements and report back results thereof to the management system 160. As already mentioned, the performance measurements comprise performance measurements regarding the transport network 150. The network element 151; 152; 153; 154; 155; 156, or the performing circuitry 703 comprised in the network element 151; 152; 153; 154; 155; 156, is configured to perform, according to the received one or more requests, said performance measurements.

The network element 151; 152; 153; 154; 155; 156, or the sending port 702 comprised in the network element 151; 152; 153; 154; 155; 156, may be configured to send, to the management system 160 in response to the received one or more requests, said one or more reports with results from the performed performance measurements.

The embodiments of the network element 151; 152; 153; 154; 155; 156, i.e. any of the network elements 151-156, may be fully or partly implemented through one or more processors, such as a processor 705 depicted in FIG. 7, together with a computer program for performing the functions and actions of embodiments herein relating to the network element 151; 152; 153; 154; 155; 156. In some embodiments the circuitry and ports discussed above may be fully or partially implemented by the processor 705.

In some embodiments, illustrated with support from the schematic drawings in FIGS. 8a-c, further explained separately below, there is provided a computer program 801b that when executed by a processor, e.g. the processor 705, causes the network element 151; 152; 153; 154; 155; 156 to perform the method according to embodiments herein as described above.

In some embodiments, also illustrated with support from the schematic drawings in FIGS. 8a-c, there is provided a computer program product, comprising a computer-readable medium and the computer program 801b stored on the computer-readable medium. Non-limiting examples of the computer-readable medium is a memory card or a memory stick 802b as in FIG. 8a, a disc storage medium 803b such as a CD or DVD as in FIG. 8b, a mass storage device 804b as in FIG. 8c. The mass storage device 804b is typically based on hard drive(s) or Solid State Drive(s) (SSD). The mass storage device 804b may be such that is used for storing data accessible over a computer network 805b, e.g. the Internet or a Local Area Network (LAN).

The computer program 801b may furthermore be provided as a pure computer program or comprised in a file or files. The file or files may be stored on the computer-readable memory and e.g. available through download e.g. over the computer network 805b, such as from the mass storage device 804b via a server. The server may e.g. be a web or file transfer protocol (ftp) server. The file or files may e.g. be executable files for direct or indirect download to and execution on the network element 151; 152; 153; 154; 155; 156, e.g. on the processor 705, or may be for intermediate download and compilation involving the same or another processor to make them executable before further download and execution.

The network element 151; 152; 153; 154; 155; 156 may further comprise a memory 706, depicted in FIG. 7, comprising one or more memory units. The memory 706 is arranged to store data, such as configurations and/or applications involved in or for performing the functions and actions of embodiments herein.

Those skilled in the art will also appreciate that the ports and circuitry 701-704 may refer to a combination of analog and digital circuits, and/or one or more processors configured with software and/or firmware (e.g., stored in memory) that, when executed by the one or more processors such as the processor 705, perform as described above. One or more of these processors, as well as the other digital hardware, may be included in a single ASIC, or several processors and various digital hardware may be distributed among several separate components, whether individually packaged or assembled into a SoC.

As a further example, the network element 151; 152; 153; 154; 155; 156 may comprise a processing unit 707, which may comprise one or more of the circuit(s) and/or port(s) etc mentioned above. As used herein, the term “processing circuit” may relate to a processing unit, a processor, an application specific integrated circuit (ASIC), a field-programmable gate array (FPGA) or the like. As an example, a processor, an ASIC, an FPGA or the like may comprise one or more processor kernels. In some examples, the processing circuit may be embodied by a software and/or hardware module.

FIGS. 8a-c, already mentioned above, are schematic drawings for illustrating embodiments related to computer program embodiments and have been used and discussed above. Note that the same FIGS. 8a-c have been used to illustrate separate embodiments regarding the management system 160 and the network element. The only reason for this is to avoid duplicating the illustrations in FIG. 8a-c, and shall thus not be construed as that e.g. computer programs related to the management system 160 and the network element 151; 152; 153; 154; 155; 156 are the same and/or need to be stored together on the same computer readable medium. To accentuate that FIGS. 8a-c in fact show separate embodiments, different numerals have been used for the same element show in FIGS. 9a-c, e.g. there are two separate computer programs 801a and 801b, which may be on respective separate computer readable medium, e.g. the computer program 801a on memory stick 802a, and separate from this, the computer program 801b on another memory stick 802b.

As used herein, the term “memory” may refer to a hard disk, a magnetic storage medium, a portable computer diskette or disc, flash memory, random access memory (RAM) or the like. Furthermore, the memory may be an internal register memory of a processor.

As used herein, the expression “configured to” may mean that a processing circuit is configured to, or adapted to, by means of software or hardware configuration, perform one or more of the actions described herein.

As used herein, the terms “number”, “value” may be any kind of digit, such as binary, real, imaginary or rational number or the like. Moreover, “number”, “value” may be one or more characters, such as a letter or a string of letters. “number”, “value” may also be represented by a bit string.

As used herein, the expression “in some embodiments” has been used to indicate that the features of the embodiment described may be combined with any other embodiment disclosed herein.

As used herein, the expression “transmit” and “send” are typically interchangeable. These expressions may include transmission by broadcasting, uni-casting, group-casting and the like. In this context, a transmission by broadcasting may be received and decoded by any authorized device within range. In case of uni-casting, one specifically addressed device may receive and encode the transmission. In case of group-casting, a group of specifically addressed devices may receive and decode the transmission.

When using the word “comprise” or “comprising” it shall be interpreted as non-limiting, i.e. meaning “consist at least of”.

In the drawings and specification, there have been disclosed exemplary embodiments of the invention. However, many variations and modifications can be made to these embodiments without substantially departing from the principles of the present invention. Accordingly, although specific terms are employed, they are used in a generic and descriptive sense only and not for purposes of limitation.

Even though embodiments of the various aspects have been described, many different alterations, modifications and the like thereof will become apparent for those skilled in the art. The described embodiments are therefore not intended to limit the scope of the present disclosure.

1. A method, performed by a management system, for handling performance monitoring in a wireless communications system, wherein the wireless communications system comprises a transport network relating to infrastructure for data transport in the wireless communications system, which data transport supports communication between logical network nodes of the wireless communications system, wherein the method comprises:
monitoring one or more key performance indicators, “KPIs”, of the wireless communications system,
detecting, based on a management system configuration, that the monitored one or more KPIs indicate a key performance degradation,
identifying network elements associated with the transport network, which network elements at least potentially are involved in causing the key performance degradation, and
sending, to the identified network elements, one or more requests requesting the identified network elements to perform performance measurements and report results thereof to the management system, which performance measurements comprise measurements regarding the transport network.

2. The method as claimed in claim 1, wherein the identification of the network elements is based on network topology information.

3. The method as claimed in claim 1, wherein said one or more requests further request the identified network elements to perform the performance measurements in a synchronized manner.

4. The method as claimed in claim 1, wherein the performance measurements are of one or more types that are relevant based on the one or more KPIs.

5. The method as claimed in claim 1, wherein said management system configuration is determined by an operator of the wireless communications system.

6. The method as claimed in claim 1, wherein the detection of the monitored KPI indicating the key performance degradation is in response to detection by the management system that at least one network element of the network elements internally has detected a local performance degradation.

7. The method as claimed in claim 6, wherein the detection of the local performance degradation is based on a network element configuration configuring said at least one network element, which network element configuration is determined by an operator of the wireless communications system.

8. The method as claimed in claim 1, further comprising:
receiving, from the network elements in response to the sent one or more requests, reports with results from the performance measurements,
correlating information comprising information from the received reports, and
providing a report, based on the correlated information, indicating possible causes of the key performance degradation.

9. A computer program that when executed by a processor causes the management system to perform the method according to claim 1.

10. (canceled)

11. A method, performed by a network element, for handling performance monitoring in a wireless communications system, wherein the wireless communications system comprises a transport network relating to infrastructure for data transport in the wireless communications system, which data transport supports communication between logical network nodes of the wireless communications system, the network element being associated with the transport network, wherein the method comprises:
receiving, from a management system, one or more requests requesting performance measurements and report back results thereof to the management system, which performance measurements comprise performance measurements regarding the transport network, and
performing, according to the received one or more requests, the performance measurements.

12. The method as claimed in claim 11, wherein said one or more requests further request the network element to perform the performance measurements in a synchronized manner in relation to other performance measurements performed by other one or more network elements.

13. The method as claimed in claim 11, wherein the performance measurements are of one or more types that are relevant based on one or more key performance indicators, “KPIs”, of the wireless communications system, which KPIs are monitored by the management system.

14. The method as claimed in claim 11, wherein the method further comprises:
sending, to the management system in response to the received one or more requests, one or more reports with results from the performed performance measurements.

15. The method as claimed in claim 11, wherein the method further comprises:
detecting, internally within the network element, a local performance degradation based on internal performance monitoring, and
sending, to the management system, a message informing about the detected local performance degradation;
and/or,
performing, in response to the detected local performance degradation, local performance measurements, and
sending, to the management system, one or more reports with results from the local performance measurements.

16. The method as claimed in claim 15, wherein the internal detection of the local performance degradation is based on a configuration of the network element, which configuration is determined by an operator of the wireless communications system.

17. A computer program that when executed by a processor causes the network element to perform the method according to claim 11.

18. (canceled)

19. A management system for handling performance monitoring in a wireless communications system, wherein the wireless communications system comprises a transport network relating to infrastructure for data transport in the wireless communications system, which data transport supports communication between logical network nodes of the wireless communications system, wherein the management system is configured to:
monitor one or more key performance indicators, “KPIs”, of the wireless communications system,
detect, based on a management system configuration, that the monitored one or more KPIs indicate a key performance degradation,
identify network elements associated with the transport network, which network elements at least potentially are involved in causing the key performance degradation, and
send, to the identified network elements, one or more requests requesting the identified network elements to perform performance measurements and report results thereof to the management system, which performance measurements comprise measurements regarding the transport network.

20. The management system as claimed in claim 19, wherein the identification of the network elements is based on network topology information.

21. The management system as claimed in claim 19, wherein said one or more requests further request the identified network elements to perform the performance measurements in a synchronized manner.

22. The management system as claimed in claim 19, wherein the performance measurements are of one or more types that are relevant based on the one or more KPIs.

23. The management system as claimed in claim 19, wherein said management system configuration is determined by an operator of the wireless communications system.

24. The management system as claimed in claim 19, wherein the detection of the monitored KPI indicating the key performance degradation is in response to detection by the management system that at least one network element of the network elements internally has detected a local performance degradation.

25. The management system as claimed in claim 24, wherein the detection of the local performance degradation is based on a network element configuration configuring said at least one network element, which network element configuration is determined by an operator of the wireless communications system.

26. The management system claimed in claim 19, wherein the management system is further configured to:
receive, from the network elements in response to the sent one or more requests, reports with results from the performance measurements,
correlate information comprising information from the received reports, and
provide a report, based on the correlated information, indicating possible causes of the key performance degradation.

27. A network element for handling performance monitoring in a wireless communications system, wherein the wireless communications system comprises a transport network relating to infrastructure for data transport in the wireless communications system, which data transport supports communication between logical network nodes of the wireless communications system, the network element being associated with the transport network, wherein the network element is configured to:
receive, from a management system, one or more requests requesting performance measurements and report back results thereof to the management system, which performance measurements comprise performance measurements regarding the transport network, and
perform, according to the received one or more requests, the performance measurements.

28. The network element as claimed in claim 27, wherein said one or more requests further request the network element to perforin the performance measurements in a synchronized manner in relation to other performance measurements performed by other one or more network elements.

29. The network element as claimed in claim 27, wherein the performance measurements are of one or more types that are relevant based on one or more key performance indicators, “KPIs”, of the wireless communications system, which KPIs are monitored by the management system.

30. The network element as claimed in claim 27, wherein the network element is further configured to:
send, to the management system in response to the received one or more requests, one or more reports with results from the performed performance measurements.

31. The network element as claimed in claim 27 wherein the network element is further configured to:
detect, internally within the network element, a local performance degradation based on internal performance monitoring,
send, to the management system, a message informing about the detected local performance degradation,
and/or
perform, in response to the detected local performance degradation, local performance measurements, and
send, to the management system, one or more reports with results from the local performance measurements.

32. The network element as claimed in claim 31, wherein the internal detection of the local performance degradation is based on a configuration of the network element, which configuration is determined by an operator of the wireless communications system.
